(19) United States
(12) Patent Application Publication
(10) Pub. No.: US 2014/0374474 A1
(43) Pub. Date: Dec. 25, 2014

(54) In-Store Content Sampling and Shopping Bag Techniques For Electronic Devices

(71) Applicant: barnesandnoble.com IIc, New York, NY (US)

(72) Inventors: Chen-Je Huang, Menlo Park, CA (US); Shaun Saperstein, San Carlos, CA (US)

(73) Assignee: barnesandnoble.com IIc, New York, NY (US)

(21) Appl. No.: 13/924,129

(22) Filed: Jun. 21, 2013

(51) Int. Cl. G06Q 30/06

(52) U.S. Cl. CPC G06Q 30/0623
USPC 235/375

(57) ABSTRACT

In-store sampling techniques using short-range wireless communication are disclosed. An NFC-enabled device may transmit an NFC signal that can automatically power an NFC tag located on an item in a store and read information stored on the tag. The information may be associated with digital content relating to the item containing the tag, and the NFC-enabled device may receive in-store access to that digital content. The item in the store may be a book and the digital content may be an electronic copy of the book, for example. The digital content may be added to the device's shopping bag or wish list and the content may be downloaded or streamed to the device through a store's local network. The in-store sampling techniques may allow consumption of the digital content while connected to the store's network, and upon leaving the store access to the digital content is removed from the device.

### FIELD OF THE DISCLOSURE

This disclosure relates to electronic display devices, and more particularly, to mobile computing devices utilizing short-range wireless technology.

### BACKGROUND

Electronic display devices such as tablets, eReaders, mobile phones, smart phones, personal digital assistants (PDAs), and other such touch screen electronic display devices are commonly used for displaying consumable content. The content may be, for example, an eBook, an online article or blog, images, a movie or video, a map, just to name a few types. Such display devices are also useful for displaying a user interface that allows a user to interact with an application running on the device. The user interface may include, for example, one or more touch screen controls and/or one or more displayed labels that correspond to nearby hardware buttons. The touch screen display may be backlit or not, and may be implemented for instance with an LED screen or an electrophoretic display. Such devices may also include other touch sensitive surfaces, such as a track pad (e.g., capacitive or resistive touch sensor) or touch sensitive housing (e.g., acoustic sensor).

### BRIEF DESCRIPTION OF THE DRAWINGS

FIGS. 1 a-b illustrate an example electronic touch screen device having an in-store sampling mode configured in accordance with an embodiment of the present invention.

FIGS. 1c-d illustrate example configuration screen shots of the user interface of the electronic device shown in FIGS. 1 a-b, configured in accordance with an embodiment of the present invention.

FIG. 2a illustrates a block diagram of an electronic touch screen device configured in accordance with an embodiment of the present invention.

FIG. 2b illustrates a block diagram of a communication system including the electronic device of FIG. 2a, configured in accordance with an embodiment of the present invention.

FIGS. 3a-d illustrate an example in-store sampling mode of an electronic touch screen device, in accordance with an embodiment of the present invention.

FIGS. 4a-c illustrate an example in-store sampling mode of an electronic touch screen device, in accordance with another embodiment of the present invention.

FIG. 5 illustrates a method for providing an in-store sampling mode in an electronic touch screen device, in accordance with an embodiment of the present invention.

### DETAILED DESCRIPTION

In-store digital content sampling techniques using short-range wireless communication are disclosed. In one example embodiment, an mobile computing device suitable for consuming the digital content is enabled with a near field communication (NFC) module, and the NFC-enabled device may transmit an NFC signal that can automatically power an NFC tag located on a physical item (such as a book) in a brick-and-mortar store (such as a bookstore) and read information stored on the tag. The information may be a unique identifier associated with digital content relating to the item containing the tag. Once the information on the tag has been read by the mobile computing device, the device may associate that information with the correct digital content and provide access to the digital content on the device. The item in the store may be, for example, a text book and the digital content may be an electronic copy of that book. The digital content may be added to or otherwise indicated in the device's shopping bag and/or wish list and the content may be downloaded or streamed to the device through a store's wireless network. While inside the store and connected to the store's wireless network, a user may be able to sample the digital content using an unlimited in-store reading function. Upon leaving the store, the digital content may be automatically removed from the device, and in some cases the device may display a purchase prompt suggesting that the user buy a copy of the digital content sampled in the store. In some embodiments, the purchase prompt may also be provided at some later time, such as after the user has left the store and attempts to access an icon representative of that digital content wherein the icon comprises a product ID code and a URL to a webpage allowing online purchase of that digital content.

General Overview

As previously explained, electronic display devices such as tablets, eReaders, and smart phones are commonly used for displaying user interfaces and consumable content. The user of such devices can typically consume and purchase digital content with relative ease. In some instances, while visiting a physical bookstore, the user may wish to sample digital content. While online shopping and sampling functions exist for sampling digital content prior to purchasing, an in-store sampling mode as described herein may provide a more intuitive or otherwise positive user experience.

Thus, and in accordance with an embodiment of the present invention, in-store sampling techniques are disclosed utilizing short-range electromagnetic fields for the purposes of automatically identifying radio frequency (RF) tags attached to physical objects such as books, videos and music CDs and/or other digital content (e.g., games, artwork, functional applications such as word processors, etc). The tags contain electronically stored information associated with digital content relating to the physical object to which they are tagged. In some embodiments, the techniques described herein allow users to sample physical books or magazines digitally on their mobile computing devices (e.g., tablet, eReader, laptop, smart phone). In physical bookstores, for example, a shopper having a mobile electronic device enabled with an in-store sampling mode as provided herein may tap on a book containing a short-range wireless tag and add a digital copy of the book to the device's shopping bag (or otherwise provided access to the digital book) for reading the book digitally in the store (rather than reading the physical copy). Upon leaving the store, the items will automatically disappear from their device and/or the user can be prompted to purchase the sampled items, in accordance with some embodiments. In one embodiment, the in-store sampling mode is configured to leave an icon representative of the digital content on the user's device, the icon including a product ID (e.g., UPC or other product code) and a URL that is accessed in response to the icon being selected. The URL can be a link to a webpage that allows for purchasing of the digital content. In another embodiment, in addition to being able to sample the full book in-store, after the user/device leaves the store, the user may still be access to the full book for a period of time thereafter (e.g., one hour), or the percentage the user is able to sample out-of-store may be higher than the typical sampling portion of the book (typical sampling portion is about 5% of content, so user might be allowed to sample, for instance, 25-50% of that content after leaving store). To encourage a user to visit a physical store, the in-store experience (including being able to read the full book) may be extended to all items that the user has physically tagged. Numerous variations on presenting in-store and out-of-store purchase opportunities for the sampled digital content will be apparent in light of this disclosure.

The principles provided herein equally apply to any short-range wireless technologies; however, for ease of description, examples are provided with NFC-enabled electronic devices and NFC tags. In general, many features that use NFC could alternatively use other forms of RFID technology, other short distance wireless information transfer techniques, or they can employ a camera or scanner to capture a visible pattern (e.g., use a smartphone to photograph a bar code, QR code, or the actual item, like a book's cover, or use a laser scanner to scan a bar code). As will be appreciated, proprietary or non-standard communications protocols involving any signal that travels a short distance—sound, magnetic or capacitive fields, vibration, etc. may also be implemented.

NFC is a set of standards that can enable short-range wireless communication. Although NFC can be used in different operating modes, this disclosure is primarily concerned with an electronic device implementing the read/write NFC operating mode for the purpose of reading NFC tag types (typically passive devices), such as an NFC tag embedded in a book or magazine (or other digital content) on a bookstore shelf. For example, and in accordance with various embodiments of the present invention, techniques are disclosed for using an NFC-enabled electronic device to read data from an NFC tag, associate that tag with specific digital content, allow in-store sampling of that digital content, and place that digital content into the device's shopping cart or wish list.

In one embodiment, NFC may operate at about 13.56 MHz on an ISO/IEC 18000-3 air interface and at rates ranging from about 106 kbits/s to 424 kbits/s. In some cases, the read/write NFC mode on the RF interface may be compliant with the ISO 14443 and FeliCa schemes. Typically, NFC uses magnetic induction between two loop antennas located within each other's near field, effectively forming an air-core transformer. In one example embodiment, the NFC module of an electronic device acts as an initiator to actively generate a radio frequency (RF) field that can power an NFC tag located inside a book (the passive target). In such an example, the NFC module automatically detects and initiates communication with an NFC tag when it is within the particular working distance of the tag. The theoretical working distance using compact standard antennas is up to 20 cm; however, a more practical working distance is 4 cm. In some embodiments, the NFC-enabled device may need to physically touch an NFC tag in order to read data from the tag as described herein (or the working distance may be so small that it may appear that a physical touch is needed). The location of the NFC module within the NFC-enabled device and/or the NFC tag within the book, as well as the respective near field ranges of the NFC-enabled device and the NFC tag may affect the distance and/or location requirements for NFC-based wireless connections. In some embodiments, the NFC module may provide a carrier field and the NFC tag may answer by modulating the existing field. In this mode, the NFC tag draws its operating power from the electromagnetic field provided by the NFC module, thus making the NFC tag a transponder.

In some embodiments, NFC tags may only have sufficient space to store a unique identifier and/or a short web address. They may not be able to store a full eBook or other digital content. In one such case, what is stored on the tag is a unique identifier and/or web address that allows for easy association of any given tag with specific content, actions, messages, transactions, etc. In one embodiment, once the NFC-enabled device enters the near field range of the NFC tag within the book, the NFC tag is detected and an NFC-based wireless connection is automatically initiated. In such an embodiment, the NFC-enabled device reads a unique identifier that has been saved on the NFC tag. The device may then associate that unique identifier with specific digital content (e.g., the eBook version of a physical book containing the NFC tag, or the eGame version of a physical game containing the NFC tag, or a video containing the NFC tag, or a software application containing the NFC tag), and the device may then request access to the digital content from a server or cloud-based service. In some cases, the request may include an identification of the device that has been previously registered with the cloud-based service. In one embodiment, relying on the NFC standard allows the user to automatically detect and read an NFC tag without first finding and opening a specific application on the electronic device. In one such case, the user must only unlock or otherwise make accessible the mobile computing device, tap that device to an NFC-tagged item, and the in-store sampling mode of the device will do the work of finding and operating the appropriate application for processing the tag.

The device may connect to the server having access to the desired digital content via the Internet, or other suitable electronic communication network (e.g., local and/or wide area networks). When the in-store sampling mode is engaged, the device may be connected to the store's Internet connection, thus allowing unlimited in-store reading of the tagged digital content, in some embodiments. In other embodiments, access may be provided to a content server that is on a local network of the store. In some cases, the device may automatically open the digital content associated with the NFC tag, while in other cases the content may be added to or otherwise indicated in the user's shopping bag and/or wish list. In one embodiment, an animation may display a thumbnail of the digital content on the user's device when it is brought within the near field range of the NFC tag in order to confirm to the user that the NFC connection was successfully created. Although the example of eBooks is used throughout this disclosure, it will be appreciated that other forms of digital content, e.g., digital magazines, videos, music, etc. can be tagged and in-store sampled according to the techniques described herein.

Architecture

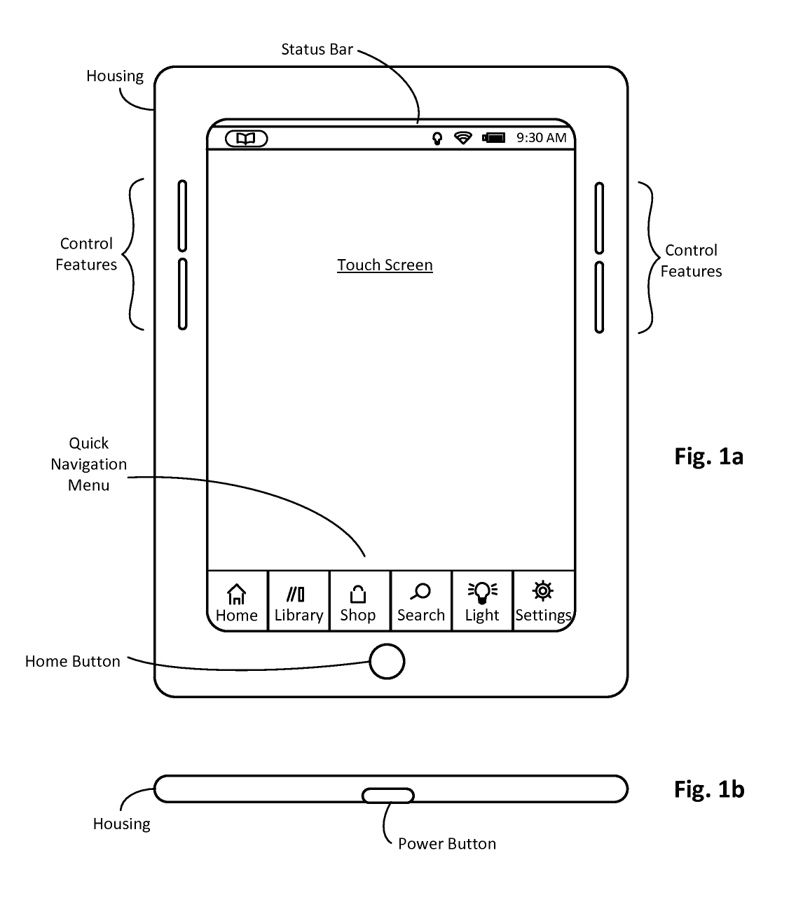

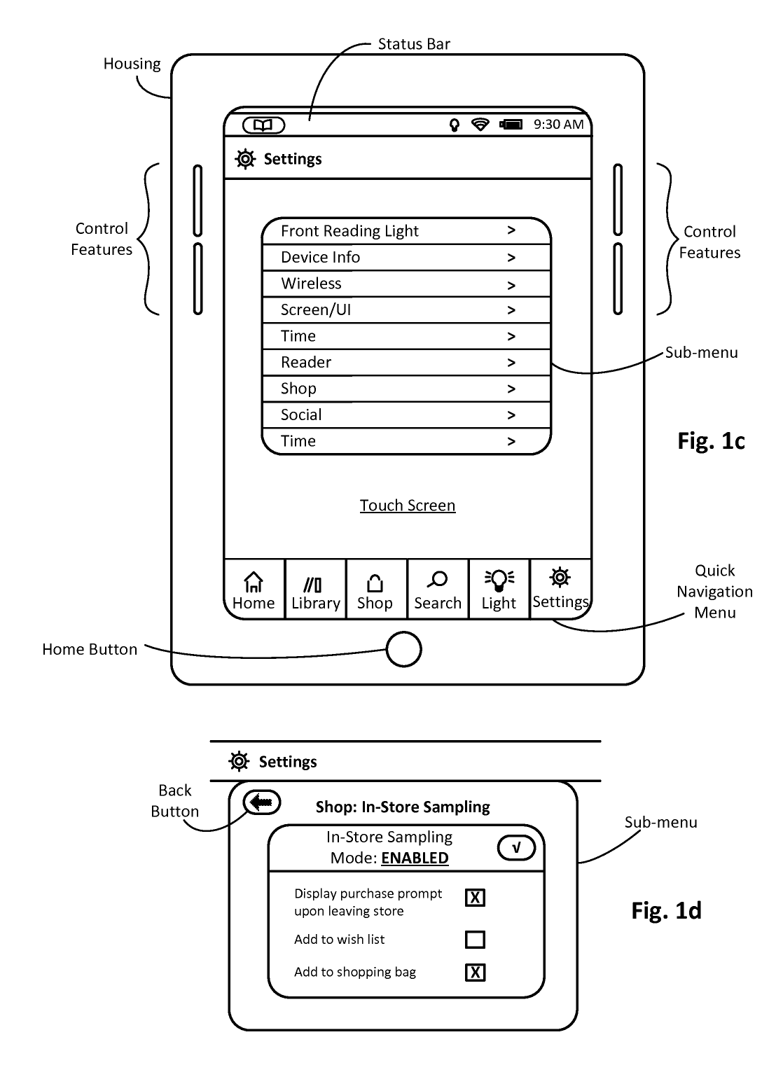

FIGS. 1 a-b illustrate an example electronic touch sensitive device having an in-store sampling mode configured in accordance with an embodiment of the present invention. As can be seen, in this example embodiment, the touch sensitive surface is a touch screen display. The device could be, for example, a tablet such as the NOOK® tablet or eReader by Barnes & Noble. In a more general sense, the device may be any electronic device having a touch sensitive user interface for detecting direct touch or otherwise sufficiently proximate contact, and capability for displaying content to a user, such as a mobile phone or mobile computing device such as a laptop, a desktop computing system, a television, a smart display screen, or any other device having a touch sensitive display or a non-sensitive display screen that can be used in conjunction with a touch sensitive surface. As will be appreciated in light of this disclosure, the claimed invention is not intended to be limited to any specific kind or type of electronic device or form factor.

As can be seen with this example configuration, the device comprises a housing that includes a number of hardware features such as a power button, control features, and a press-button (sometimes called a home button herein). A user interface is also provided, which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other embodiments may have fewer or additional such UI features, or different UI features altogether, depending on the target application of the device. Any such general UI controls and features can be implemented using any suitable conventional or custom technology, as will be appreciated.

The hardware control features provided on the device housing in this example embodiment are configured as elongated press-bars and can be used, for example, to page forward (using the top press-bar) or to page backward (using the bottom press-bar), such as might be useful in an eReader application. The power button can be used to turn the device on and off, and may be used in conjunction with a touch-based UI control feature that allows the user to confirm a given power transition action request (e.g., such as a slide bar or tap point graphic to turn power off). Numerous variations will be apparent, and the claimed invention is not intended to be limited to any particular set of hardware buttons or UI features, or device form factor.

In this example configuration, the home button is a physical press-button that can be used as follows: when the device is awake and in use, pressing the button will display the quick navigation menu, which is a toolbar that provides quick access to various features of the device. The home button may also be configured to cease an active function that is currently executing on the device (such as an in-store reading application), or close a configuration sub-menu that is currently open. The button may further control other functionality if, for example, the user presses and holds the home button. For instance, an example such push-and-hold function could engage a power conservation routine where the device is put to sleep or an otherwise lower power consumption mode. So, a user could grab the device by the button, press and keep holding as the device is stowed into a bag or purse. Thus, one physical gesture may safely put the device to sleep. In such an example embodiment, the home button may be associated with and control different and unrelated actions: 1) show the quick navigation menu; 2) exit a configuration sub-menu; and 3) put the device to sleep. As can be further seen, the status bar may also include a book icon (upper left corner). In some cases, selecting the book icon may provide bibliographic information on the content or provide the main menu or table of contents for the book, movie, playlist, or other content.

In one particular embodiment, an in-store sampling mode configuration sub-menu, such as the one shown in FIG. 1d, may be accessed by selecting the Settings option in the quick navigation menu which causes the device to display the general sub-menu shown in FIG. 1 c. From this general sub-menu, the user can select any one of a number of options, including one designated Shop in this specific example case. Selecting this sub-menu item may cause the configuration sub-menu of FIG. 1 d to be displayed, in accordance with an embodiment. In other example embodiments, selecting the Shop option may present the user with a number of additional sub-options, one of which may include a so-called “in-store sampling” option, which may then be selected by the user so as to cause the in-store sampling mode configuration sub-menu of FIG. 1d to be displayed. Any number of such menu schemes and nested hierarchies can be used, as will be appreciated in light of this disclosure. In other example embodiments, the in-store sampling mode is hard-coded such that no configuration sub-menus are needed or otherwise provided (e.g., adding in-store access to an eBook or other content to the device by detecting an NFC tag as described herein, with no user configuration needed). The degree of hard coding versus user-configurability can vary from one embodiment to the next, and the claimed invention is not intended to be limited to any particular configuration scheme of any kind, as will be appreciated.

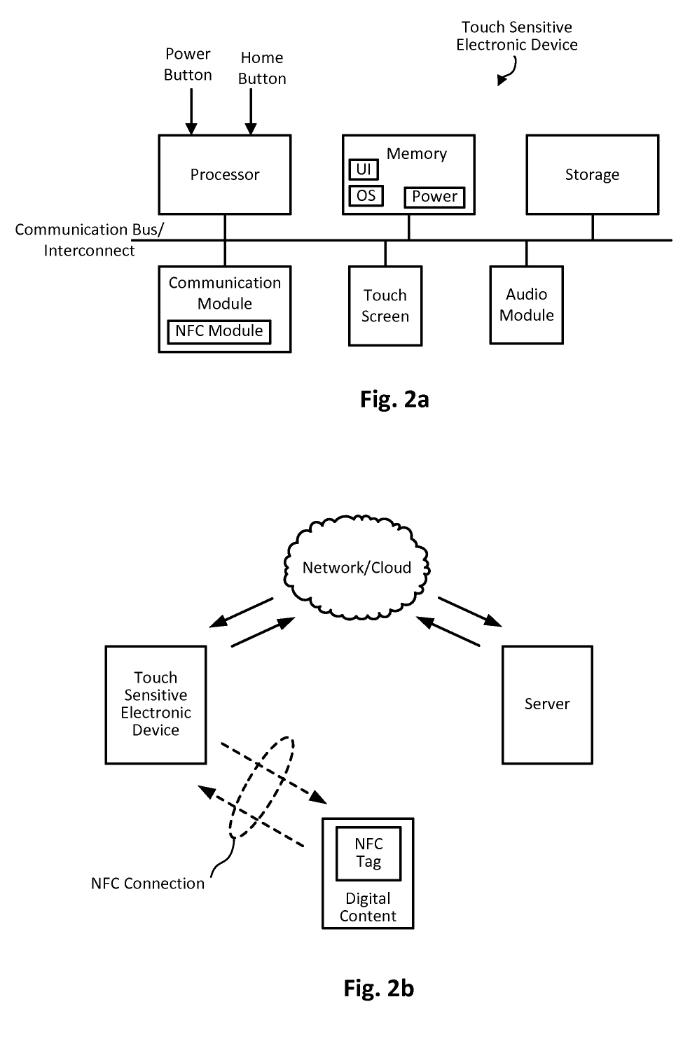

As will be appreciated, the various UI control features and sub-menus displayed to the user are implemented as touch screen controls in this example embodiment. Such UI screen controls can be programmed or otherwise configured using any number of conventional or custom technologies. In general, the touch screen display translates a touch (direct or hovering, by a user's hand, a stylus, or any other suitable implement) in a given location into an electrical signal which is then received and processed by the device's underlying operating system (OS) and circuitry (processor, display controller, etc.). In some instances, note that the user need not actually physically touch the touch sensitive device to perform an action. For example, the touch screen display may be configured to detect input based on a finger or stylus hovering over the touch sensitive surface (e.g., within 3 centimeters of the touch screen or otherwise sufficiently proximate to be detected by the touch sensing circuitry). Additional example details of the underlying OS and circuitry in accordance with some embodiments will be discussed in turn with reference to FIG. 2a.

The touch sensitive surface (or touch sensitive display, in this example case) can be any surface that is configured with touch detecting technologies, whether capacitive, resistive, acoustic, active-stylus, and/or other input detecting technology, including direct contact and/or proximate contact. In some embodiments, the screen display can be layered above input sensors, such as a capacitive sensor grid for passive touch-based input, such as with a finger or passive stylus contact in the case of a so-called in-plane switching (IPS) panel, or an electro-magnetic resonance (EMR) sensor grid for sensing a resonant circuit of a stylus. In some embodiments, the touch sensitive display can be configured with a purely capacitive sensor, while in other embodiments the touch screen display may be configured to provide a hybrid mode that allows for both capacitive input and EMR input, for example. In still other embodiments, the touch sensitive surface is configured with only an active stylus sensor. Numerous touch screen display configurations can be implemented using any number of known or proprietary screen based input detecting technologies. In any such embodiments, a touch sensitive controller may be configured to selectively scan the touch sensitive surface and/or selectively report user inputs detected directly on or otherwise sufficiently proximate to (e.g., within a few centimeters, or otherwise sufficiently close so as to allow detection) the detection surface (or touch sensitive display, in this example case).

As previously explained, and with further reference to FIGS. 1 c and 1 d, once the Settings sub-menu is displayed (FIG. 1 c), the user can then select the Shop option. In response to such a selection, the in-store sampling mode configuration sub-menu shown in FIG. 1 d can be provided to the user, in accordance with one such example embodiment. The user can configure a number of features with respect to the in-store sampling mode, in this example case. For instance, the configuration sub-menu includes a UI check box that when checked or otherwise selected by the user, effectively enables the in-store sampling mode (shown in the enabled state); unchecking the box disables the function. Other embodiments may have the in-store sampling mode always enabled, or enabled by a physical switch or button located on the device, for example. In some cases, the user may configure the destination on the electronic device where the in-store sampled content will be accessed. For instance, the user may desire to add the tagged content to the device's wish list or shopping bag. In this particular example, the user has configured the in-store sampling mode to save the sampled items to a shopping bag by selecting the appropriate UI check box. Furthermore, the device has been configured to display a purchase prompt upon leaving the store, in this particular embodiment. In such an example, the purchase prompt may include a message suggesting that the user purchase one or more of the books that were sampled in the store.

As can be further seen, a back button arrow UI control feature may be provisioned on the screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired. The configuration sub-menu shown in FIG. 1 d is presented merely as an example of how an in-store sampling mode may be configured by the user, and numerous other configurable or hard-codable aspects will be apparent in light of this disclosure. Note that in some embodiments the in-store sampling mode may be visually and/or aurally demonstrated or otherwise confirmed to the user via animations and/or sound effects. Such animations and sound effects may be used to provide clarity to the function being performed or otherwise enhance the user experience. In some embodiments, such animations and sound effects may be user-configurable, while in other embodiments they are hard-coded.

FIG. 2a illustrates a block diagram of an electronic touch screen device configured in accordance with an embodiment of the present invention. As can be seen, this example device includes a processor, memory (e.g., RAM and/or ROM for processor workspace and storage), additional storage/memory (e.g., for content), a communications module, a touch screen, and an audio module. A communications bus and interconnect is also provided to allow inter-device communication. Other typical componentry and functionality not reflected in the block diagram will be apparent (e.g., battery, co-processor, etc). The touch screen and underlying circuitry is capable of translating a user's contact (direct or proximate) with the touch screen into an electronic signal that can be manipulated or otherwise used to trigger a specific user interface action, such as those provided herein. The principles provided herein equally apply to any such touch sensitive devices. For ease of description, examples are provided with touch screen technology.

In this example embodiment, the memory includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C, C++, objective C, JavaScript, custom or proprietary instruction sets, etc), and encoded on a machine readable medium, that when executed by the processor (and/or co-processors), carries out the functionality of the device including a UI having an in-store sampling mode as variously described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose-built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The processor can be any suitable processor (e.g., Texas Instruments OMAP4, dual-core ARM Cortex-A9, 1.5 GHz), and may include one or more co-processors or controllers to assist in device control. In this example case, the processor receives input from the user, including input from or otherwise derived from the power button and the home button. The processor can also have a direct connection to a battery so that it can perform base level tasks even during sleep or low power modes. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage (e.g., for storing consumable content and user files) can also be implemented with any suitable memory and size (e.g., 2 GBytes of flash memory). The display can be implemented, for example, with a 7 to 9 inch 1920×1280 IPS LCD touchscreen touch screen, or any other suitable display and touchscreen interface technology.

The communications module can include, for instance, any suitable 802.11 b/g/n WLAN chip or chip set, which allows for connection to a local network, and so that content can be exchanged between the device and a remote system (e.g., content provider or repository depending on the application of the device). As can be seen, the communications module also includes an NFC module configured to execute, for instance, any suitable protocol which allows for the detection and reading of an NFC tag located on or within a book or other physical content item (e.g., DVD package, game package, software application package, etc), or to otherwise provide a communication link between the device and a short-range wireless tag. The NFC module receives tag data which can then be received or otherwise used by the in-store sampling mode executing on the processor, as will be explained in turn. In some specific example embodiments, the device housing that contains all the various componentry measures about 7″ to 9″ high by about 5″ to 6″ wide by about 0.5″ thick, and weighs about 7 to 8 ounces. Any number of suitable form factors can be used, depending on the target application (e.g., laptop, desktop, mobile phone, etc). The device may be smaller, for example, for smartphone and tablet applications and larger for smart computer monitor and laptop and desktop computer applications.

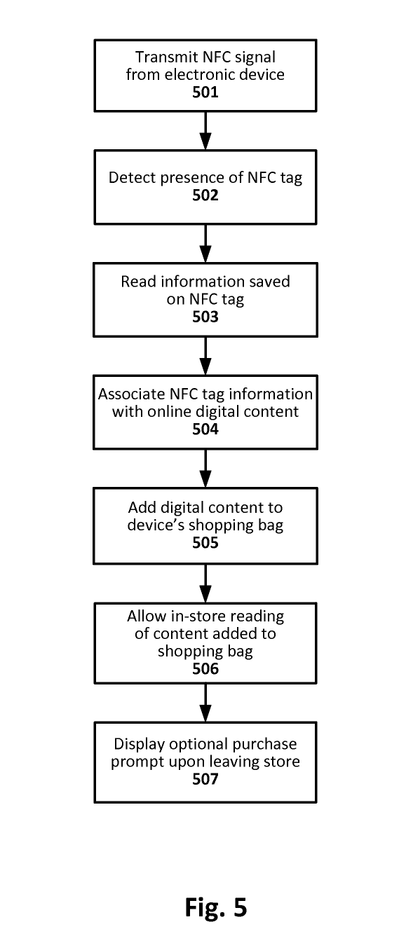

The operating system (OS) module can be implemented with any suitable OS, but in some example embodiments is implemented with Google Android OS or Linux OS or Microsoft OS or Apple OS. As will be appreciated in light of this disclosure, the techniques provided herein can be implemented on any such platforms. The power management (Power) module can be configured as typically done, such as to automatically transition the device to a low power consumption or sleep mode after a period of non-use. A wake-up from sleep mode can be achieved, for example, by a physical button press and/or a touch screen swipe or other action. The user interface (UI) module can be, for example, based on touchscreen technology and the various example screen shots and use-case scenarios shown in FIGS. 1a, 1c-d, 3a-d, and 4a-c, and in conjunction with the in-store sampling methodologies demonstrated in FIG. 5, which will be discussed in turn. The audio module can be configured to speak or otherwise aurally present, for example, a selected eBook or other textual content, and/or to provide verbal and/or other sound-based cues and prompts to guide the in-store sampling process, as will be appreciate in light of this disclosure. Numerous commercially available text-to-speech modules can be used, such as Verbose text-to-speech software by NCH Software. In some example cases, if additional space is desired, for example, to store digital books or other content and media, storage can be expanded via a microSD card or other suitable memory expansion technology (e.g., 32 GBytes, or higher). Further note that although a touch screen display is provided, other embodiments may include a non-touch screen and a touch sensitive surface such as a track pad, or a touch sensitive housing configured with one or more acoustic sensors, etc.

Client-Server System

FIG. 2b illustrates a block diagram of a communication system configured in accordance with an embodiment of the present invention. As can be seen, the system generally includes an electronic touch sensitive device (such as the one in FIG. 2a) that is capable of communicating with a server via a network/cloud, as well as creating an NFC connection with an NFC tag. In one example embodiment, the device may transmit an NFC signal that can power an NFC tag located on or within a hardcopy book or other content (e.g., music CD, game CD, software CD, movie DVD) inside a bookstore and the device may read information stored on the tag. The information stored on the tag may be a unique identifier associated with digital content relating to the book, such as an electronic copy of the book. In one such example, the digital content is stored on a remote server and the device may communicate with the server via a network/cloud in order to download the content to the device or stream the content onto the device.

In some cases, a cloud-based service may actually comprise several servers performing interconnected and distributed functions. In this example embodiment, the electronic touch sensitive device may be, for example, an eBook reader, a mobile cell phone, a laptop, a tablet, desktop, or any other NFC-enabled touch sensitive computing device. The network/cloud may be a public and/or private network, such as a private local area network operatively coupled to a wide area network such as the Internet. In one example embodiment, the network comprises a private network available inside a bookstore, which allows the device user to access and read digital content for free within the bookstore. In this example embodiment, the server may be local or remote to the bookstore and programmed or otherwise configured to receive content requests from a user via the touch sensitive device and to respond to those requests by performing a desired function or providing the user with requested or otherwise recommended content. In some such embodiments, the server is configured to remotely store digital content and remotely provision an in-store sampling function as provided herein to the touch screen device (e.g., via JavaScript or other browser based technology). In other embodiments, portions of the in-store sampling methodology can be executed on the server and other portions of the methodology can be executed on the device. Numerous server-side/client-side execution schemes can be implemented to facilitate an in-store sampling function in accordance with an embodiment, as will be apparent in light of this disclosure.

In-Store Sampling Mode Examples

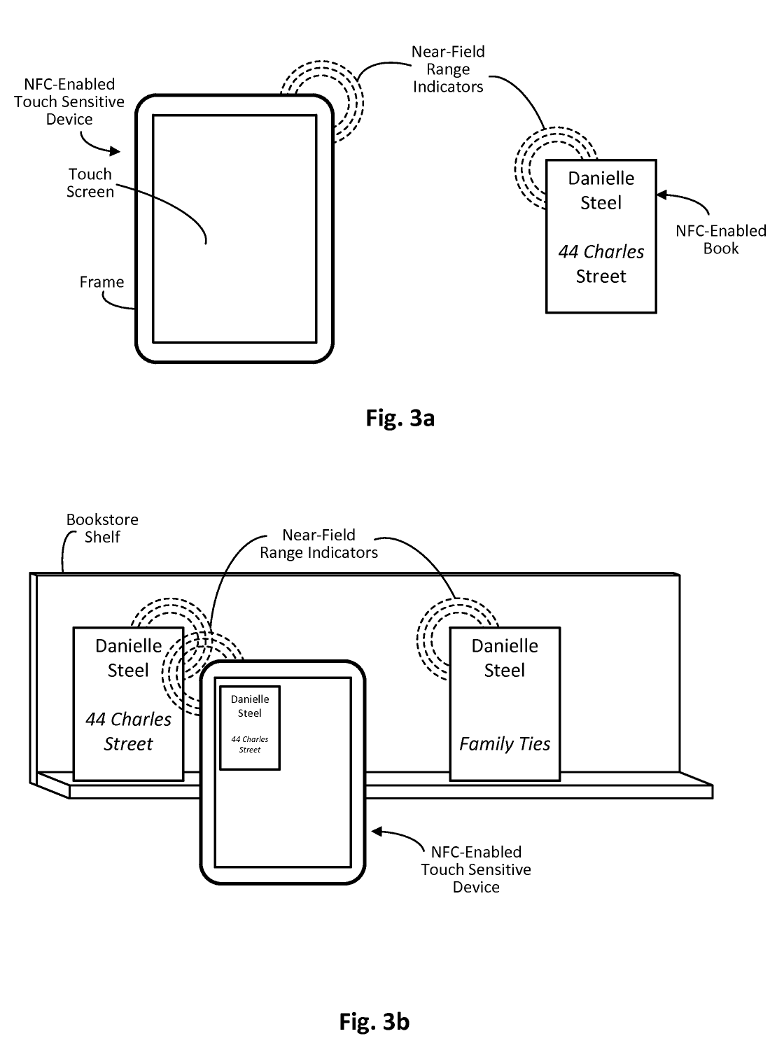

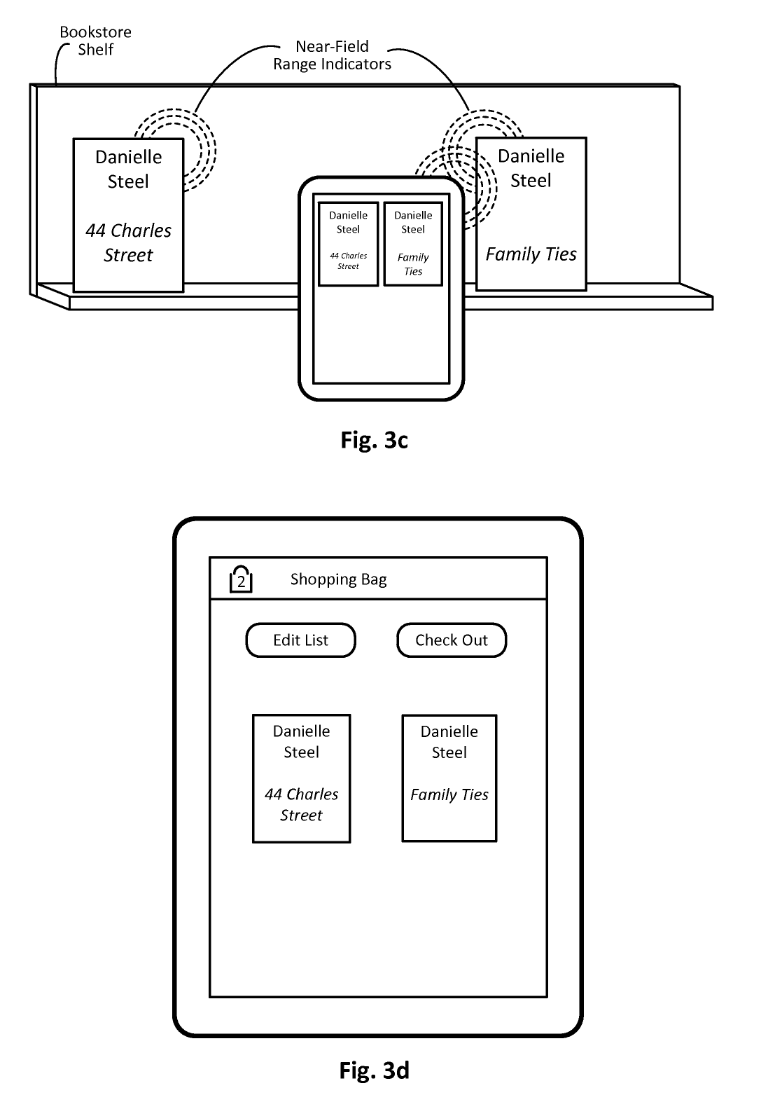

FIGS. 3a-d collectively illustrate an example in-store sampling mode that can be applied to a touch sensitive electronic device, in accordance with an embodiment of the present invention. Generally: FIG. 3a shows an NFC-enabled touch sensitive device and an NFC-enabled book, along with indicators of their corresponding near field ranges; FIG. 3b shows two NFC-enabled books on a store bookshelf and the NFC-enabled touch sensitive device within the near field range of one of the books; FIG. 3c shows the electronic device within near field range of the second book; and FIG. 3d shows an example shopping bag of the electronic device after the two books have been tagged using the in-store sampling mode.

FIG. 3a shows the device frame surrounding the touch screen of the NFC-enabled device along with an NFC-enabled book. In this particular embodiment, the book contains an NFC tag that may be located within the pages or cover sleeve of the book. The user can interact with the touch screen device using fingers or other suitable implement. FIG. 3b shows the other NFC-enabled device entering the near field range of the NFC tagged book. Once the device enters the near field range of the NFC tag within the book, the tag is detected and an NFC-based wireless connection is automatically initiated. In some embodiments, an actual physical touch or apparent physical touch (e.g., where the near field range is less than 4 cm) may be required to detect the book's NFC tag. The location of the NFC module in the NFC-enabled device and/or the NFC tag within the book, as well as the respective near field ranges of the NFC-enabled device and the NFC tag may affect the distance and/or location requirements for NFC-based wireless connections. As can be seen in this embodiment, the near field ranges of the NFC-enabled device emanates from the top corner of the device such that the corner of the device has to come into close proximity to the book's NFC tag in order to initiate an NFC connection.

Once the user puts the electronic device within range of the NFC tag located on the first book, the device reads the unique identifier saved on the book's NFC tag, associates that identifier with the corresponding eBook content, and adds that content to the device's shopping bag. In this particular example, an image of the book cover may appear on the device screen to indicate to the user that access to the digital book has been added via the shopping bag. In the example shown in FIG. 3c, the user puts the electronic device within range of the NFC tag located on the second book, thus adding access to the eBook version of that book via the device's shopping bag. FIG. 3d shows an example screenshot of the device's shopping bag after the two books have been tagged. In this example, the shopping bag includes touch screen UI buttons that allow the user to edit the shopping bag, check out, or read the eBooks by tapping on the book image. In one example embodiment, while in the bookstore the user may read the eBooks (e.g., using an unlimited in-store reading option), edit the shopping bag, or purchase the eBooks. Access may be provided in the form of streaming content or a fleeting copy that is placed on the device. Any number of temporary access methods can be used so as to allow a user to meaningfully sample the content in-store. In another embodiment, in addition to being able to sample the full book in-store, after the device leaves the store there may still be access to the full book for a period of time (e.g., one hour), or the percentage of the book the user is able to sample out-of-store may be higher than the average.

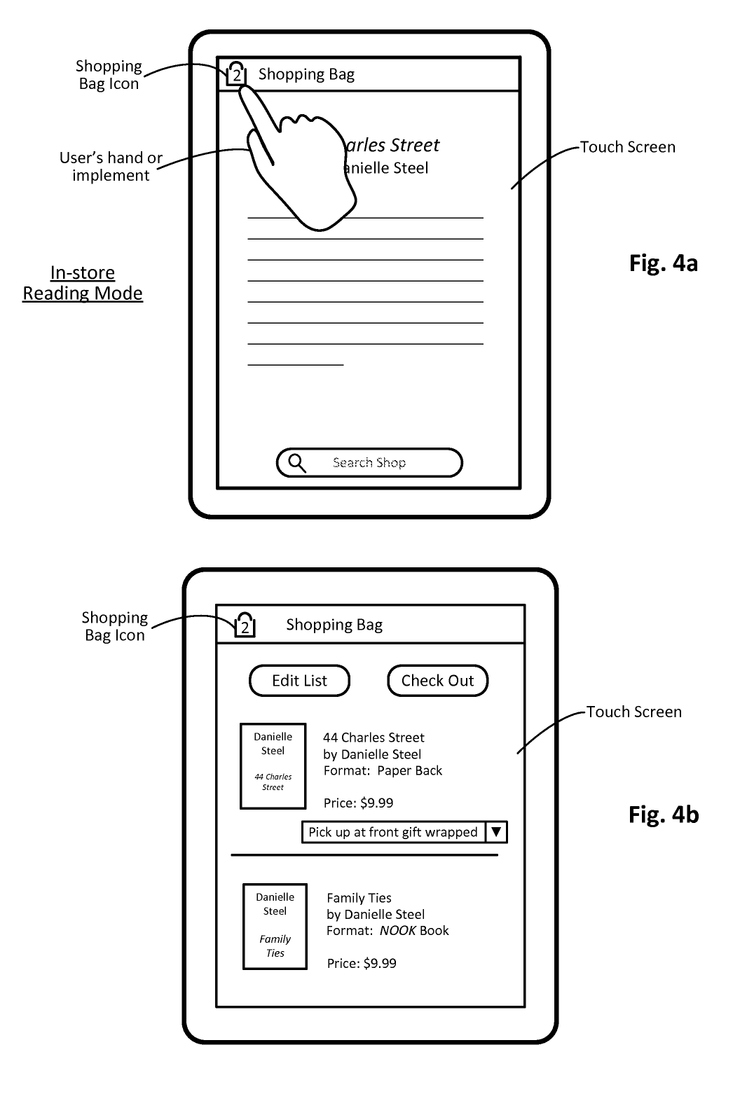

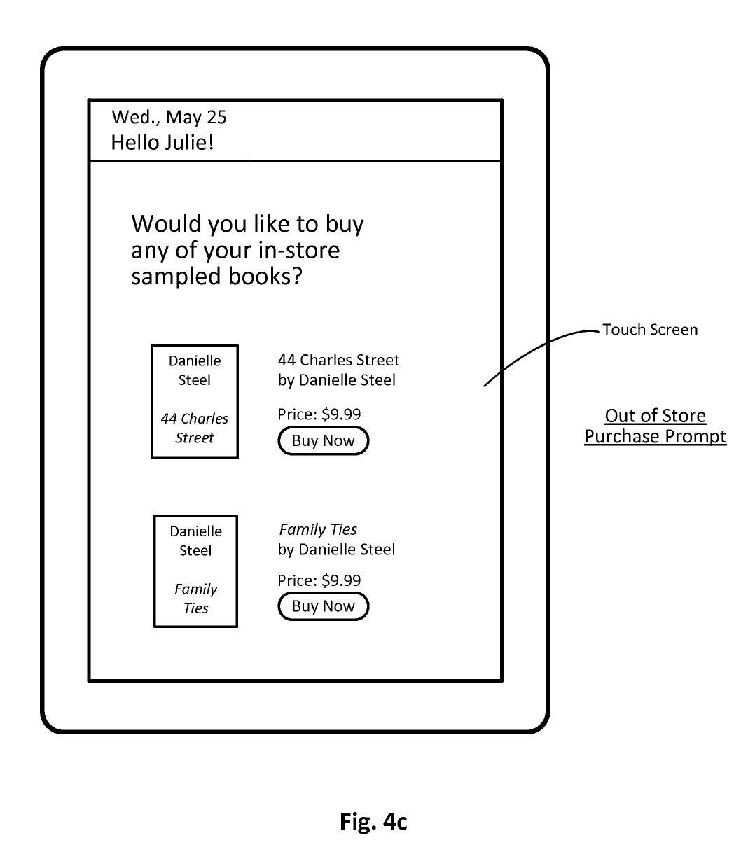

FIGS. 4a-c collectively illustrate an example in-store sampling mode that can be applied to a touch sensitive electronic device, in accordance with another embodiment of the present invention. Generally: FIG. 4a shows an NFC-enabled touch sensitive device operating in the in-store reading mode; FIG. 4b shows an NFC-enabled touch sensitive device displaying the device's shopping bag; and FIG. 4c shows an NFC-enabled touch sensitive device displaying a purchase prompt upon leaving the physical bookstore.

FIG. 4a shows the electronic device displaying the first page of a book that the user is sampling in the bookstore. The user has tagged two books, adding them to the device's shopping bag, and the shopping bag icon in the top corner of the device displays a shopping bag icon with an indicator of the number of items within the shopping bag. The user can interact with the touch screen device using fingers or other suitable implement. By tapping the shopping bag icon the user can access the device's shopping bag, as shown in the example in FIG. 4b. In this example, the device is displaying thumbnail images of the two books included in the shopping bag, along with a brief description of the book including the title, author's name, book format, price, etc. In this specific example, the user may edit the shopping bag or check out online by selecting the appropriate touchscreen UI control feature. In another example embodiment, the editing function may be simplified to address a primary use case of removing an item from the user's shopping bag by displaying an “X” UI control feature next to each content icon. In such an example, tapping or otherwise selecting the “X” button will remove the content from the shopping bag. Furthermore, the shopping bag may include a drop down menu that allows the user to purchase the book online and pick it up gift wrapped at the bookstore front desk, in some embodiments. Such a feature may be useful where the user wishes to read a sample of a book on an eReader device but decides to purchase a hardcopy of the book. Upon leaving the bookstore, the unlimited in-store reading mode is no longer available and the user may wish to purchase one or more of the in-store sampled materials. FIG. 4c shows an example purchase prompt that may be displayed to the user the next time the device is activated after leaving the bookstore. As previously explained, the in-store sampling mode may be configured to leave the icon representative of the digital content (such as those shown in FIG. 4c) on the user's device, wherein the icon includes a product ID (e.g., UPC or other product code) and a URL that can be accessed in response to the icon being selected. The URL can be a link to a webpage that allows for purchasing of the digital content, even after the user has left the store.

Methodology

FIG. 5 illustrates a method for providing an in-store sampling mode in an electronic touch screen device, in accordance with an embodiment of the present invention. This example methodology may be implemented, for instance, by the UI module of the example touch screen device shown in FIG. 2a, or the example touch screen device shown in FIG. 2b (e.g., with the UI provisioned to the client by the server). To this end, the in-store sampling mode can be implemented in software, hardware, firmware, or any combination thereof, as will be appreciated in light of this disclosure.

As can be seen, in this example case, the method starts by transmitting 501 an NFC signal from the electronic device. The method may continue with detecting 502 the presence of an NFC tag within the near field range of the NFC-enabled device. As discussed above, the near field range of the NFC-enabled device and/or NFC tag may range from about 4 cm to 20 cm, in some example embodiments. The method may continue with reading 503 the information stored on the NFC tag. In some embodiments, the information may include a unique identification number associated with the digital version of a book. In some cases, in order to create an NFC connection and read the information saved on the NFC tag, the NFC-enabled device may need to physically touch an NFC tag or a book containing an NFC tag, or the working distance of the tag may be so small that it may appear that a physical touch is needed. The method may continue with associating 504 the information stored on the NFC tag with online digital content. The method may continue with adding 505 access to the digital content via the device's shopping bag and/or wish list, or otherwise providing in-store access to the content (whether through downloading an actual copy or streaming or any other suitable means to provide limited access to the desired content). Once access to the content is added to the device, the method may continue with allowing 506 in-store reading of the digital content. In some cases, the digital content associated with the NFC tag may initially be saved on a remote server, and the digital content may be downloaded or streamed onto the device in order to allow in-store reading/sampling of the digital content. In one such embodiment, unlimited in-store reading is only allowed while within a physical bookstore, and when the device is taken out of the store the digital content is automatically removed from the device or otherwise disabled from further use. While in the store, the user may read the digital content and/or easily purchase a copy of the content. The method may also continue with displaying 507 an optional purchase prompt upon leaving the store. In one example, if the user has sampled a book or music album in the store without purchasing it, the device may prompt the user to purchase a copy of the sampled content once the unlimited in-store sampling feature is no longer available. This post-sampling purchase opportunity may remain on the device.

Numerous variations and embodiments will be apparent in light of this disclosure. One example embodiment of the present invention provides a device including a display for displaying digital content to a user and allowing user input. The device also includes a short-range wireless communications module for transmitting a short-range wireless signal configured to detect and initiate communication with a short-range wireless tag and read a unique identifier from the tag located on an item in a store. The device also includes a user interface including an in-store sampling mode configured to associate the unique identifier with digital content related to the item containing the tag and provide access to the digital content to the device. In some cases, the short-range wireless signal includes at least one of a radio frequency signal, sound wave, optical signal, vibration, magnetic field, and/or capacitive field. In some cases, the short-range wireless tag includes at least one of an RFID tag, NFC tag, bar code, and/or QR code. In some cases, the item containing the tag includes at least one of a book, a magazine, a DVD, a software application CD, a game CD, and/or a music CD. In some cases, the short-range wireless tag includes an NFC tag and the short-range wireless communications module includes an NFC module configured to power and read the NFC tag. In some cases, an image of the digital content is displayed on the display to confirm that access to the digital content has been provided to the device. In some cases, the digital content is indicated in the device's shopping bag and/or wish list. In some such cases, the in-store sampling mode is further configured to allow unlimited in-store reading of the digital content while the device is connected to a local network of the store. In some such cases, the digital content is streamed to the device through a local network of the store. In other such cases, access to the digital content is removed from the device upon leaving the store. In some cases, the in-store sampling mode is further configured to display a purchase prompt on the display suggesting that the user purchase the digital content sampled in the store. In some cases, the device is an eBook reader, a mobile cell phone, a laptop, or a tablet.

Another example embodiment of the present invention provides a mobile computing system including a processor and a touch screen display for displaying content to a user and allowing user input, a processor, a short-range wireless communications module for transmitting a short-range wireless signal configured to detect and initiate communication with a short-range wireless tag and read a unique identifier from the tag located on an item in a store, and a user interface including an in-store sampling mode executable by the processor and configured to associate the unique identifier with digital content associated with the item containing the tag and provide access to the digital content to the device. In some cases, access to the digital content is removed from the device upon leaving the store. In some cases, the short-range wireless tag includes an NFC tag and the short-range wireless communications module includes an NFC module configured to power and read the NFC tag. In some cases, the item containing the tag is a hardcopy book and the digital content is a digital copy of the book, and wherein the in-store sampling mode is further configured to allow unlimited in-store reading of the digital content while the device is connected to a local network of the store.

Another example embodiment of the present invention provides a computer program product including a plurality of instructions non-transiently encoded thereon to facilitate operation of an electronic device according to a process. The computer program product may include one or more computer readable mediums such as, for example, a hard drive, compact disk, memory stick, server, cache memory, register memory, random access memory, read only memory, flash memory, or any suitable non-transitory memory that is encoded with instructions that can be executed by one or more processors, or a plurality or combination of such memories. In this example embodiment, the process is configured to transmit from an electronic device a short-range wireless signal configured to detect and initiate communication with a short-range wireless tag located on an item in a store, read a unique identifier from the short-range wireless tag, associate the unique identifier with digital content relating to the item containing the tag, and provide access to the digital content on the electronic device. In some cases, the short-range wireless tag includes a passive NFC tag and the short-range wireless signal includes an NFC signal configured to power and read the NFC tag. In some cases, the process further includes removing access to the digital content from the device upon leaving the store. In some cases, the item containing the tag is a hardcopy book and the digital content is a digital copy of the book, and the process further includes allowing unlimited in-store reading of the digital content while the electronic device is connected to a local network of the store.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device, comprising:
a display for displaying digital content to a user and allowing user input;
a short-range wireless communications module for transmitting a short-range wireless signal configured to detect and initiate communication with a short-range wireless tag and read a unique identifier from the tag located on an item in a store; and
a user interface including an in-store sampling mode configured to associate the unique identifier with digital content related to the item containing the tag and provide access to the digital content to the device.

2. The device of claim 1 wherein the short-range wireless signal comprises at least one of a radio frequency signal, sound wave, optical signal, vibration, magnetic field, and/or capacitive field.

3. The device of claim 1 wherein the short-range wireless tag comprises at least one of an RFID tag, NFC tag, bar code, and/or QR code.

4. The device of claim 1 wherein the item containing the tag comprises at least one of a book, a magazine, a DVD, a software application CD, a game CD, and/or a music CD.

5. The device of claim 1 wherein the short-range wireless tag comprises an NFC tag and the short-range wireless communications module comprises an NFC module configured to power and read the NFC tag.

6. The device of claim 1 wherein an image of the digital content is displayed on the display to confirm that access to the digital content has been provided to the device.

7. The device of claim 1 wherein the digital content is indicated in the device's shopping bag and/or wish list.

8. The device of claim 7 wherein the in-store sampling mode is further configured to allow unlimited in-store reading of the digital content while the device is connected to a local network of the store.

9. The device of claim 8 wherein the digital content is streamed to the device through a local network of the store.

10. The device of claim 8 wherein access to the digital content is removed from the device upon leaving the store.

11. The device of claim 1 wherein the in-store sampling mode is further configured to display a purchase prompt on the display suggesting that the user purchase the digital content sampled in the store.

12. The device of claim 1 wherein the device is an eBook reader, a mobile cell phone, a laptop, or a tablet.

13. A mobile computing device, comprising:
a touch screen display for displaying content to a user and allowing user input;
a processor;
a short-range wireless communications module for transmitting a short-range wireless signal configured to detect and initiate communication with a short-range wireless tag and read a unique identifier from the tag located on an item in a store; and
a user interface including an in-store sampling mode executable by the processor and configured to associate the unique identifier with digital content associated with the item containing the tag and provide access to the digital content to the device.

14. The device of claim 13 wherein access to the digital content is removed from the device upon leaving the store.

15. The device of claim 13 wherein the short-range wireless tag comprises an NFC tag and the short-range wireless communications module comprises an NFC module configured to power and read the NFC tag.

16. The device of claim 13 wherein the item containing the tag is a hardcopy book and the digital content is a digital copy of the book, and wherein the in-store sampling mode is further configured to allow unlimited in-store reading of the digital content while the device is connected to a local network of the store.

17. A computer program product comprising a plurality of instructions non-transiently encoded thereon to facilitate operation of an electronic device according to the following process:
transmit from an electronic device a short-range wireless signal configured to detect and initiate communication with a short-range wireless tag located on an item in a store;
read a unique identifier from the short-range wireless tag;
associate the unique identifier with digital content relating to the item containing the tag; and
provide access to the digital content on the electronic device.

18. The computer program product of claim 17 wherein the short-range wireless tag comprises a passive NFC tag and the short-range wireless signal comprises an NFC signal configured to power and read the NFC tag.

19. The computer program product of claim 17 wherein the process further comprises: remove access to the digital content from the device upon leaving the store.

20. The computer program product of claim 17 wherein the item containing the tag is a hardcopy book and the digital content is a digital copy of the book, and wherein the process further comprises: allow unlimited in-store reading of the digital content while the electronic device is connected to a local network of the store.
